(19) United States
(12) Patent Application Publication
(10) Pub. No.: US 2012/0330667 A1
(43) Pub. Date: Dec. 27, 2012

(54) SPEECH SYNTHESIZER, NAVIGATION APPARATUS AND SPEECH SYNTHESIZING METHOD

(75) Inventors: Qinghua Sun, Tokorozawa (JP); Kenji Nagamatsu, Fuchu (JP); Yusuke Fujita, Nagareyama (JP)

(73) Assignee: Hitachi, Ltd.

(21) Appl. No.: 13/527,614

(22) Filed: Jun. 20, 2012

(30) Foreign Application Priority Data
Jun. 22, 2011 (JP) 2011-138104

(51) Int. Cl. G10L 13/08

(52) U.S. Cl. 704/260; 704/E13.011

(57) ABSTRACT

Included in a speech synthesizer, a natural language processing unit divides text data, input from a text input unit, into a plurality of components (particularly, words). An importance prediction unit estimates an importance level of each component according to the degree of how much each component contributes to understanding when a listener hears synthesized speech. Then, the speech synthesizer determines a processing load based on the device state when executing synthesis processing and the importance level. Included in the speech synthesizer, a synthesizing control unit and a wave generation unit reduce the processing time for a phoneme with a low importance level by curtailing its processing load (relatively degrading its sound quality), allocate a part of the processing time, made available by this reduction, to the processing time of a phoneme with a high importance level, and generates synthesized speech in which important words are easily audible.

### CLAIM OF PRIORITY

The present application claims priority from Japanese patent application JP 2011-138104 filed on Jun. 22, 2011, the content of which is hereby incorporated by reference into this application.

### FIELD OF THE INVENTION

The present invention relates a technique that generates synthesized speech signals from an input text.

### BACKGROUND OF THE INVENTION

Evolution of speech synthesis techniques leads to an improvement in the quality of synthesized speech and we have an increasing opportunity to hear synthesized speech produced by speech synthesis in many situations of life. For example, speech synthesis techniques are becoming widely used in services that automatically provide information using synthesized speech, such as in-vehicle navigation equipment, automatic broadcasting equipment in public facilities, e-mail reading devices, and automatic speech translation systems.

On the other hand, in most of speech synthesis systems which are now put into practical use, the quality of synthesized speech (also referred to as sound quality) has a high correlation with a load on system resources (e.g., occupancy of a CPU (Central Processing Unit) and a memory, disc access frequency, network traffic, etc.). That is, in order to produce high-quality synthesized speech, more resources need to be assigned to speech synthesis processing. Conversely, a reduction in the resources assigned to speech synthesis processing decreases the quality of synthesized speech.

In a case where a low-performance device such as car navigation equipment is equipped with a speech synthesis function, resources that are assigned to speech synthesis processing are limited and, thus, the quality of produced synthesized speech may become low. In this regard, however, the above low-performance means that resources that can be assigned to speech synthesis processing are less. In other words, since real-time performance (i.e., once the first sound of synthesized speech has been output, subsequent sounds of synthesized speech should be output seamlessly) is required for speech synthesis processing, resources that are assigned to speech synthesis processing must be adjusted accordingly for the low-performance device at the cost of sound quality. At present, many speech synthesis systems define the size of available resources (mainly, CPU and memory) that can be occupied for speech synthesis to maintain real-time performance and perform speech synthesis surely and controls the processing load for speech synthesis not to exceed the size of those resources.

A technique that adjusts the processing load on resources by detecting performance or a state of hardware and adjusting the amount of dictionary information to be used for synthesis processing depending on the detection result is disclosed, e.g., in Japanese Published Patent No. 3563756 which is hereinafter referred to as Patent Document 1.

### SUMMARY OF THE INVENTION

However, in the technique disclosed in Patent Document 1, the processing load on resources is adjusted depending on the performance or state of hardware; consequently, when the processing load is reduced, the quality of synthesized speech decreases accordingly. If such a decrease in sound quality occurs in an important component (e.g., a keyword in a sentence) for understanding the meaning of a text, there is a risk that the meaning of synthesized speech cannot be accurately conveyed to the listener of the synthesized speech. For instance, in a case where CPU is used for some other application during the synthesis of a word that is important in context and a high processing load cannot be ensured, an important word is to be output as a synthesized speech sound of low quality. This results in a problem that the meaning of an entire sentence may become hard to understand for the listener of synthesized speech.

Therefore, a challenge of the present invention is to make important words of synthesized speech easily audible.

In order to address the above challenge, a speech synthesizer pertaining to the present invention divides an input text into a plurality of components (words in concrete terms), determines the degree of how much each component (word) contributes to understanding the meaning of the text when a listener hears synthesized speech, and estimates an importance level of each component. Then, the speech synthesizer determines a processing load based on the device state when executing synthesis processing and the importance level. And, the speech synthesizer reduces the processing time for a component with a low importance level by curtailing its processing load (relatively degrading its sound quality), allocates a part of the processing time, made available by this reduction, to the processing time of a phoneme with a high importance level, and generates synthesized speech in which important words are easily audible.

According to the present invention, it is possible to make important words of synthesized speech easily audible.

### BRIEF DESCRIPTION OF THE DRAWINGS

FIG. 1 is a block diagram depicting a hardware structure of a speech synthesizer pertaining to a first embodiment;

FIG. 2 is a block diagram showing functions of the speech synthesizer pertaining to the first embodiment;

FIG. 3 is an explanatory diagram illustrating the operation of a text processing unit;

FIG. 4 is an explanatory diagram illustrating an example of targets for synthesis;

FIG. 5 is an explanatory diagram illustrating the operation of a synthesizing control unit;

FIG. 6 is an explanatory diagram illustrating an example of phoneme determining rules;

FIG. 7 is an explanatory diagram illustrating the operation of a wave generation unit;

FIG. 8 is an explanatory diagram for illustrating a process of determining a next synthesized phoneme and setting a target finish time;

FIG. 9 is an explanatory diagram for illustrating a process of determining a next synthesized phoneme and setting a target finish time;

FIG. 10 is an explanatory diagram for illustrating a process of determining a next synthesized phoneme and setting a target finish time;

FIG. 11 is an explanatory diagram for illustrating a process of determining a next synthesized phoneme and setting a target finish time;

FIG. 12 is an explanatory diagram for illustrating a process of determining a next synthesized phoneme and setting a target finish time;

FIG. 13 is an explanatory diagram for illustrating a process of determining a next synthesized phoneme and setting a target finish time;

FIG. 14 is an explanatory diagram for illustrating a process of determining a next synthesized phoneme and setting a target finish time;

FIGS. 15A and 15B are graphical representations of time sequence of speech synthesis processing by a speech synthesizer, in which FIG. 15A shows a graphical representation of speech synthesis processing according to related art and FIG. 15B shows a graphical representation of speech synthesis processing according to the embodiments described herein;

FIG. 16 is a block diagram showing a functional configuration of a speech synthesizer pertaining to a second embodiment;

FIG. 17 is a block diagram showing a functional configuration of a speech synthesizer pertaining to a third embodiment;

FIG. 18 is an explanatory diagram illustrating an example of text altering rules; and

FIG. 19 is an explanatory diagram illustrating the operation of a text processing unit.

### DETAILED DESCRIPTION OF THE PREFERRED EMBODIMENTS

In the following, preferred embodiments of a speech synthesizer and a speech synthesizing method pertaining to this invention will be described in detail with reference to the attached drawings.

### Framework

A speech synthesizer and a speech synthesizing method pertaining to embodiments described herein estimate an importance level of each of the components (words in concrete terms) of a text depending on the degree of how much each component contributes to understanding the meaning of the entire text in accordance with the context of the text for speech synthesis. And, the speech synthesizer and speech synthesizing method assign a larger amount of resources to a component (word) with a high importance level an that the component is speech synthesized at a high sound quality and assign a reduced amount of resources to speech synthesis of a component (word) with a low importance level at the cost of sound quality, thus maintaining real-time performance.

In the present invention, the reason for thus estimating an importance level of each word depending on the degree of how much the word contributes to understanding the meaning is as follows: when one speaks, it is likely that the one probably utters words, taking account of importance in some of the words to get a better understanding of what was spoken. Specifically, it is inferred that, when one speaks, the speaker may finely control the emphasis (importance) of words according to the intention of his or her utterance. When a listener hears an utterance in which the emphasis (importance) of words is finely controlled by the speaker, it is inferred that the listener may try to understand the meaning by picking up and liking some words that seem keywords.

Let us explain how this manner of utterance is reflected in the utterance of synthesized speech on car navigation equipment or the like. For instance, in an example of a phrase which is often used in car navigation “zenpou sanbayku meitoru saki, migi ni magarimasu” in Japanese language, which means “turn to the right 300 meters ahead forward”, words “sanbyaku” and “migi” which correspond to “300” and “right” have important information and other words are considered as not causing some trouble especially, even if they are inaudible. Therefore, in order to enhance understanding of the meaning of the synthesized speech, two keywords “sanbyaku (300)” and “migi (right)” are speech synthesized at a higher quality than other words. On the other hand, other words are speech synthesized at a low quality to curtail the processing load.

Thus, the speech synthesizer and the speech synthesizing method pertaining to the embodiments described herein are capable of generating synthesized speech in which important words are easily audible, while maintaining real-time performance, by changing the processing load depending on the importance level of a word. The processing load means the amount of resources such as, e.g., CPU, memory, and communication device used for the processing. Changing the processing load is provided by, for example, changing the granularity of quantization for speech synthesis processing, changing the size of a language dictionary, changing the size of speech data, changing the processing algorithm, changing the length of a text for speech synthesis, etc. Although paragraphs, sentences, phrases, words, phonemes, etc. are conceivable as units of components of a text, it is assumed that a text is divided into words (morphemes) in the embodiments described herein.

### Overview

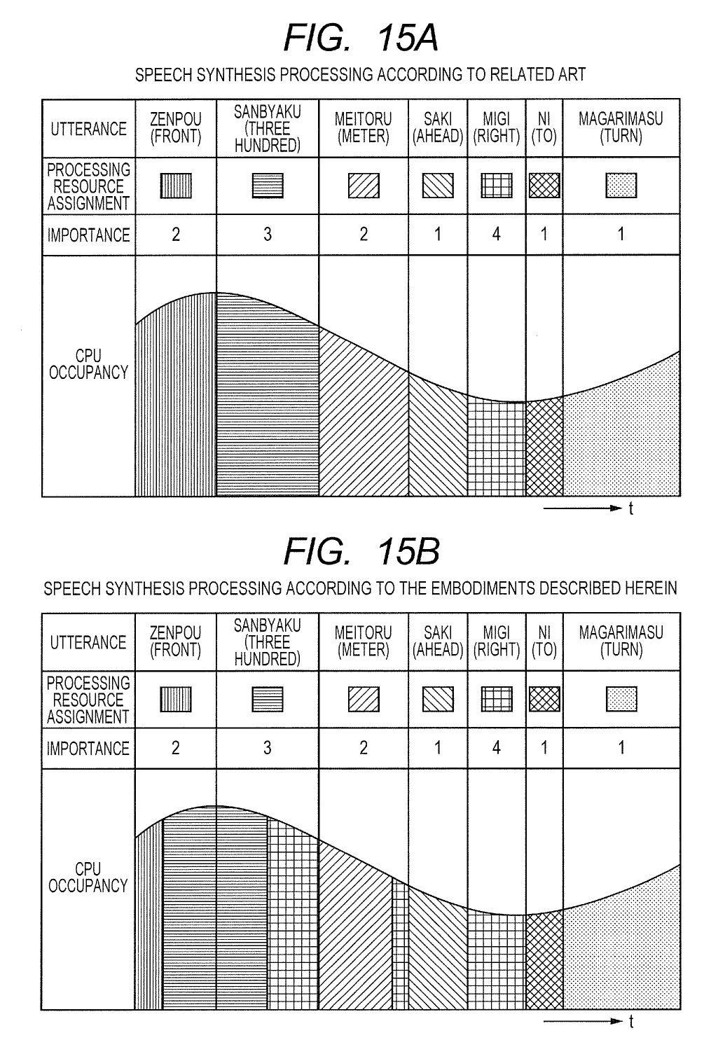

To begin with, an overview of the embodiments described herein is described using FIGS. 15A and 15B. FIG. 15A shows a graphical representation of speech synthesis processing according to related art as a comparison example and FIG. 15B shows a graphical representation of speech synthesis processing according to the embodiments described herein.

FIGS. 15A and 15B schematically show a sequence in which the words in text data “zenpou sanbayku meitoru saki, migi ni magarimasu” are processed into synthesized speech. The abscissa indicates time (t) and the ordinate indicates CPU occupancy as resources that can be assigned to speech synthesis processing. When the importance level of a word is larger, synthesized speech of higher quality is generated for the word. Thus, a larger importance level of a word indicates that a larger amount of resources needs to be assigned to the processing of the word. Hatched and dotted patterns plotted in the fields of CPU occupancy indicate that synthesis processing for a word corresponding to a pattern shown in the legend field has been executed. Each of vertical lines that separate words indicates a target finish time, i.e., a time instant by which synthesis processing must be finished so as to maintain real-time performance. For example, a vertical line between a word “zenpou” and a word “sanbyaku” indicates a target finish time by which synthesis processing of the word “zenpou” must be finished. A gentle curve represents a change in the CPU occupancy. Therefore, in FIGS. 15A and 15B, the processing load can be considered to be equivalent to an area formed by integration of CPU occupancy along the time axis. That is, each of hatched/dotted pattern regions in FIGS. 15A and 15B represents an amount of load consumed for synthesis processing of each word.

As shown in FIG. 15A, the words in text data are processed in order in which they appear in the synthesis processing related art. Consequently, the processing load (area) for a word “migi (turn)” with importance level 4 becomes smaller than the processing load (area) for a word “zenpou (forward)” with importance level 2 or a word “magarimasu (turn)” with importance level 1. That is, there would occur a risk that, despite having a high importance level, a word is speech synthesized at a low quality, since a large amount of resources cannot be assigned to its processing.

In contrast, the synthesis processing according to the embodiments described herein, shown in FIG. 15B can process a word with a low importance level with a small amount of resources, because synthesized speech for the word is generated at a relatively low quality, and its processing finishes in a short time. Thus, in a case where processing of the word has finished earlier than its target finish time, processing of a word with a relatively large importance level is executed during a surplus time. Therefore, a large amount of resources can be assigned to a word with a high importance level.

In FIG. 15B, specifically, the synthesis processing of a first word “zenpou (forward)” finishes in a short time, because its importance level is rather low (importance level 2). Thus, a surplus time before the target finish time of the word “zenpou” can be assigned to the synthesis processing of a word “sanbyaku (300)” whose importance level is rather high (importance level 3). Besides, in a case where the synthesis processing of the word “sanbyaku” has finished earlier than its target finish time, the synthesis processing of a word “migi (right)” whose importance level is high (importance level 4) is executed. Also in a case where the synthesis processing of a word “meitoru (meters)” has finished earlier than its target finish time, the synthesis processing of the word “migi” whose importance level is high (importance level 4) is executed. In this way, the synthesis processing according to the embodiments described herein reduces the processing time for a word with a low importance level by curtailing its processing load (relatively degrading its sound quality), allocates a part of the processing time, made available by this reduction, to the processing time of a phoneme whose importance level is high, and can generate synthesized speech in which important words are easily audible.

### First Embodiment

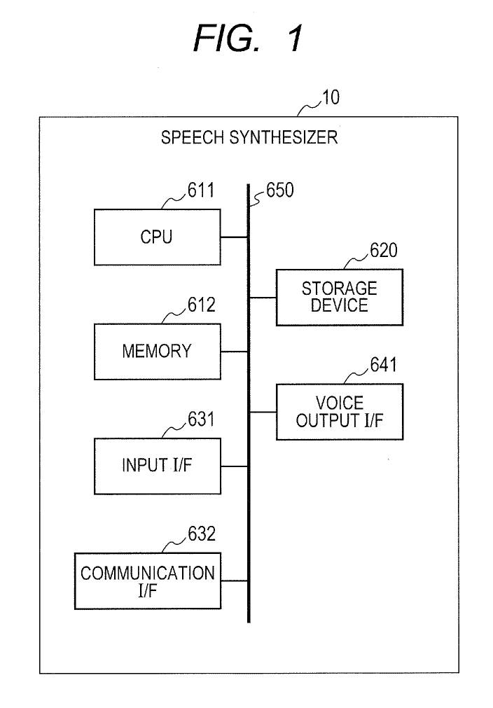

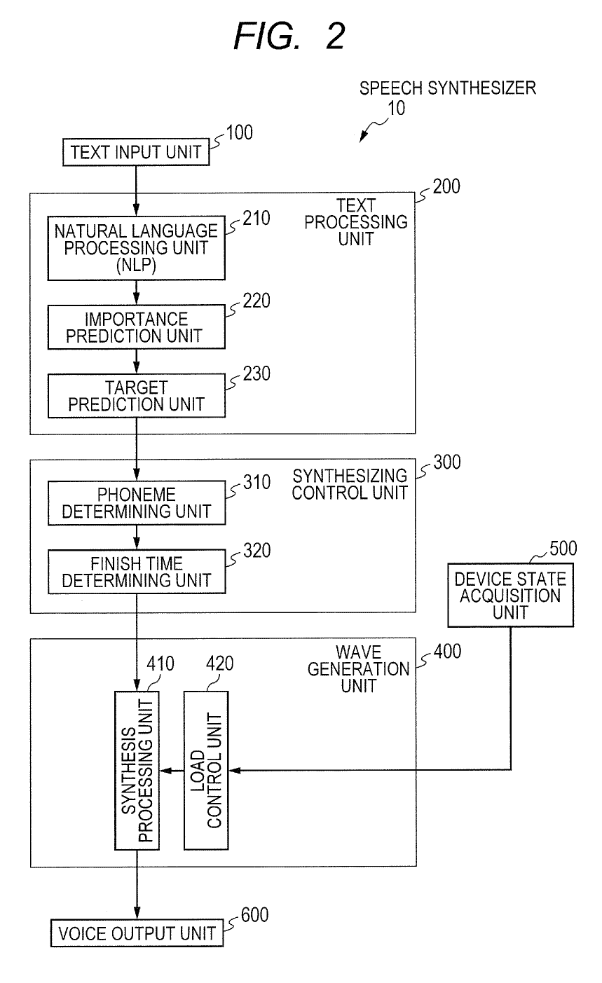

A hardware structure of a speech synthesizer pertaining to a first embodiment is described using FIG. 1. Functions of the speech synthesizer pertaining to the first embodiment are described using FIG. 2.

### Hardware Structure of Speech Synthesizer 10

As shown FIG. 1, the speech synthesizer 10 is configured with a CPU 611, a memory 612 which is a main storage, a storage device 620, an input I/F (interface) 631, a communication I/F 632 for connection to a network, and a voice output I/F 641 connecting to a speaker, and these components are interconnected by a bus 650. The speech synthesizer 10 is incorporated in a device such as, e.g., a car navigation device, mobile phone, and personal computer. Thus, each component of the hardware shown in FIG. 1 may be implemented by using the configuration of the device in which the speech synthesizer 10 is incorporated or may be provided separately from the device in which the speech synthesizer 10 is incorporated.

The CPU 611 exerts overall control of the speech synthesizer 10. The memory 612 is used as a working area for the CPU 611. The storage device 620 is a nonvolatile storage medium for which, particularly, e.g., HDD (hard disk), FD (flexible disk), flash memory, etc. can be used. In the storage device 620, various programs such as a language analysis program and a per-word importance estimation program which are used for speech synthesis processing, as will be described later, and various data such as a language analysis model and an importance analysis model are recorded.

The input I/F 631 is an interface that connects an input device (not shown) such as a keyboard and a mouse to the apparatus and accepts input of text data from the input device. The communication I/F 632 is an interface that connects the apparatus to a network via a wired or wireless channel. The voice output I/F 641 is an interface that connects a speaker to the apparatus and outputs synthesized speech signals.

### Functional Configuration of Speech Synthesizer 10

Then, the functions of the speech synthesizer 10 are described using FIG. 2. As shown in FIG. 2, the speech synthesizer 10 is configured with a text input unit 100, a text processing unit 200, a synthesizing control unit 300, a wave generation unit 400, a device state acquisition unit 500, and a voice output unit 600.

The text input unit 100 is an interface that accepts input of text data and may be, for example, a keyboard connection interface, a network connection interface, and the like. If the text input unit 100 is a keyboard connection interface, text data is received, for example, by user's key-in operation with the keyboard. If the text input unit 100 is a network connection interface, text data is received as data of information distributed by, for example, a news distribution service.

The text processing unit 200 is composed of a natural language processing unit (NLP) 210, an importance prediction unit 220, and a target prediction unit 230. The natural language processing unit 210 analyzes text data which is input from the text input unit 100 with the aid of a language analysis model which is publicly known and generates a middle language (a symbol string for synthesis) including language information such as morpheme information and prosodic boundary information. The importance prediction unit 220 estimates utterance intention from the context of the input text and estimates an importance level of each of words (corresponding to morphemes in Japanese language) of the text depending on the degree of how much the word contributes to sentence understanding with the aid of a per-word importance analysis model which is publicly known and generates a middle language with per-word importance levels. The target prediction unit 230 analyzes the middle language with per-word importance levels generated by the importance prediction unit 220 and predicts prosody information from context environment information with the aid of a target provision model which is publicly known. This prediction processing allows an acoustic feature value regarding prosody to change depending on context (contextual factor) even for a same phoneme.

The synthesizing control unit 300 is composed of a phoneme determining unit 310 and a finish time determining unit 320. The phoneme determining unit 310 determines a minimum unit for synthesis (generally a phoneme and a syllable are considered as the minimum unit, but a phoneme is assumed as the minimum unit in the following description). The finish time determining unit 320 determines a time by which synthesis processing for each phoneme should be finished (this time is hereinafter referred to as a target finish time). Although the time may be represented in absolute time such as Japan Standard Time, it is assumed that the time is represented as a relative time with reference to a time instant at which the text input unit 100 has received the beginning of a series of text data in the following description.

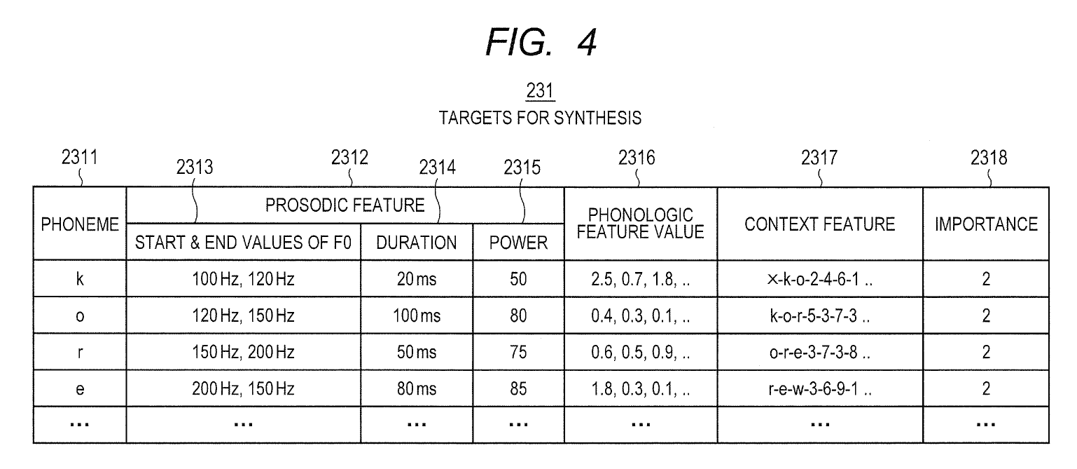

The wave generation unit 400 is composed of a synthesis processing unit 410 and a load control unit 420. The synthesis processing unit 410 generates a speech waveform signal (synthesized speech signal) of a phoneme (which hereinafter means a phoneme and its associated information, even where a phoneme is simply mentioned) which has been output from the synthesizing control unit 300. Here, the associated information includes a prosodic feature, phonologic feature value, context feature, etc. which are shown in FIG. 4. The load control unit 420 analyzes a device state acquired from the device state acquisition unit 500 which will be described later and controls resources (CPU occupancy, memory usage, disc access frequency, etc.) to be assigned to processing by the synthesis processing unit 410,

The device state acquisition unit 500 acquires information about a state of a device equipped with the speech synthesizer 10 (device state), such as a load at a predetermined time. The device state includes, for example, CPU utilization rate, memory usage, disc access frequency, network communication rate, operational status of other applications which are run concurrently, etc.

The voice output unit 600 is a device that outputs speech waveform signals generated by the wave generation unit 400 and may be, e.g., an interface for connection of a speaker or headphone, an interface for network connection, etc. The voice output unit 600 once buffers speech waveform signals received from the wave generation unit 400 into an output buffer and adjusts the order in which it outputs the speech waveform signals. If the voice output unit 600 is an interface for connection of a speaker or headphone, speech waveform signals are converted to sound waves in the speaker or headphone and output as synthesized speech. If the voice output unit 600 is an interface for network connection, speech waveform signals are distributed to, for example, some other information terminal via a network.

For each of the components of the speech synthesizer 10 shown in FIG. 2, its function is implemented by execution of a predefined program by the CPU 611 using programs and data recorded in the storage device 620.

### Operation of Each Component

Details on the operation of each component of the speech synthesizer 10 are described below.

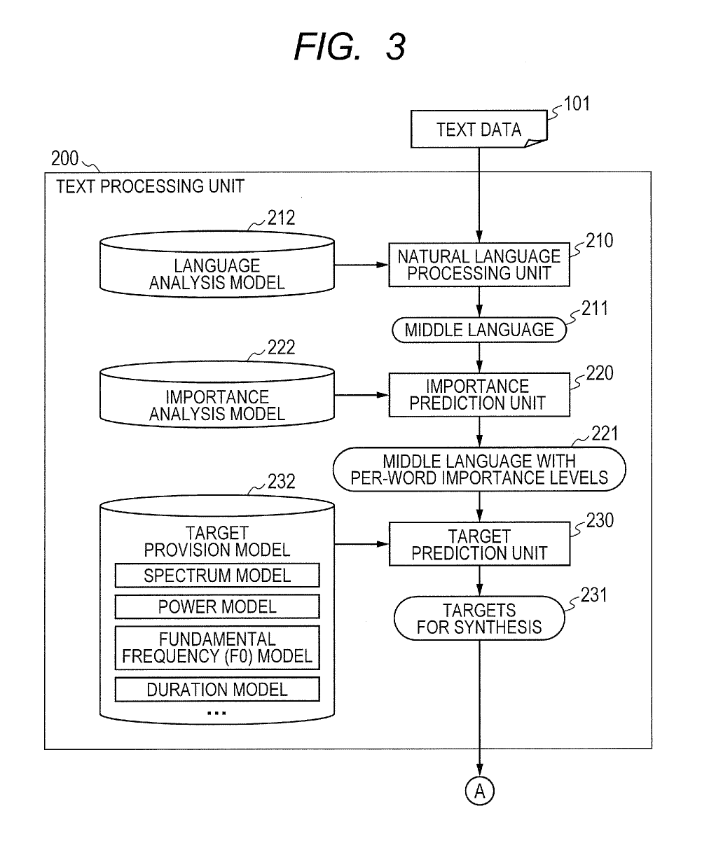

First, the operation of the text processing unit 200 is described using FIG. 3. In FIG. 3, the natural language processing unit 210 in the text processing unit 200 first receives text data 101 from the text input unit 100 (see FIG. 1).

The natural language processing unit 210 converts the text data 101 to a middle language 211 with the aid of a language analysis model 212 created beforehand. Here, the middle language 211 includes at least phonetic symbols for text reading. Besides, the middle language 211 preferably includes middle language information such as word class, prosodic boundary, sentence structure, and accent type. If middle language information is already added to a part of text data 101, the natural language processing unit 210 can use the added middle language information as is. In other words, a middle language may be set up in advance.

If text data 101 is “kore wa goosee onsee desu” in Japanese language, which means “this is synthesized speech”, the natural language processing unit 210 converts this text data 101 to a middle language 211 “(k % o) (r % e)/(w % a) # (g % oo) (s % ee)/(o % N) (s % ee)/(d % e) (s % u)”, where “%” denotes a phoneme boundary, a set of letters parentheses ( ) denotes a mora, “/” denotes a word boundary, and “#” denotes an accent phrase boundary, respectively.

The importance prediction unit 220 acquires the middle language 211 generated by the natural language processing unit 210 and estimates the importance levels of all words included in the middle language 211 with the aid of an importance analysis model 222 created beforehand. However, if importance information is added to a part or all of the words of the text data 101, the importance prediction unit 220 can use the added importance information as is. In other words, an importance level of a word may be specified in advance. Then, the importance prediction unit 220 adds estimated importance information to the middle language 211 and outputs it as a middle language with per-word importance levels 221 to the target prediction unit 230.

As for the importance analysis model 222, if sentence patterns of speech to be synthesized are definable as in the case of car navigation equipment, a method in which experts manually create the model based on experience is considered to be effective. If synthesized speech is used for news reading and the like, the importance analysis model 222 is preferably a model that is capable of estimating an importance level of a word from context, a topic, and the like using a collection of rules created by a statistical method.

In the case of the above-mentioned text data 101 “kore wa goosee onsee desu” in Japanese language, which means “this is synthesized speech”, for example, the importance levels of the words may differ depending on utterance intention. This is explained below for cases 1A and 1B as concrete examples.

Case 1A: if text data 101 has an intention that “speech being reproduced now is speech synthesized by machine, not real voice speech”, “goosee” which corresponds to “synthesized” is a keyword and the importance levels of the words may be given as follows: “{2}(k % o) (r % e)/{1}(w % a) #{4} (g % oo) (s % ee)/{3}(o % N)(s % ee)/{1}(d % e)(s % u)”. Here, numbers enclosed in curly brackets { } denote the importance levels of the words; the larger the number, the higher will be the importance level. This is true for the following description, i.e., a larger number indicates a higher importance level of a word.

Case 1B: if text data 101 has an intention that “among some pieces of speech, the speech being reproduced now, not other pieces of speech, is synthesized speech”, “kore” which corresponds to “this” is a keyword and the importance levels of the words may be given as follows: “{4}(k % o) (r % e)/{1}(w % a)#{2}(g % oo) (s % ee)/{2}(o % N)(s % ee)/{1}(d % e)(s % u)”.

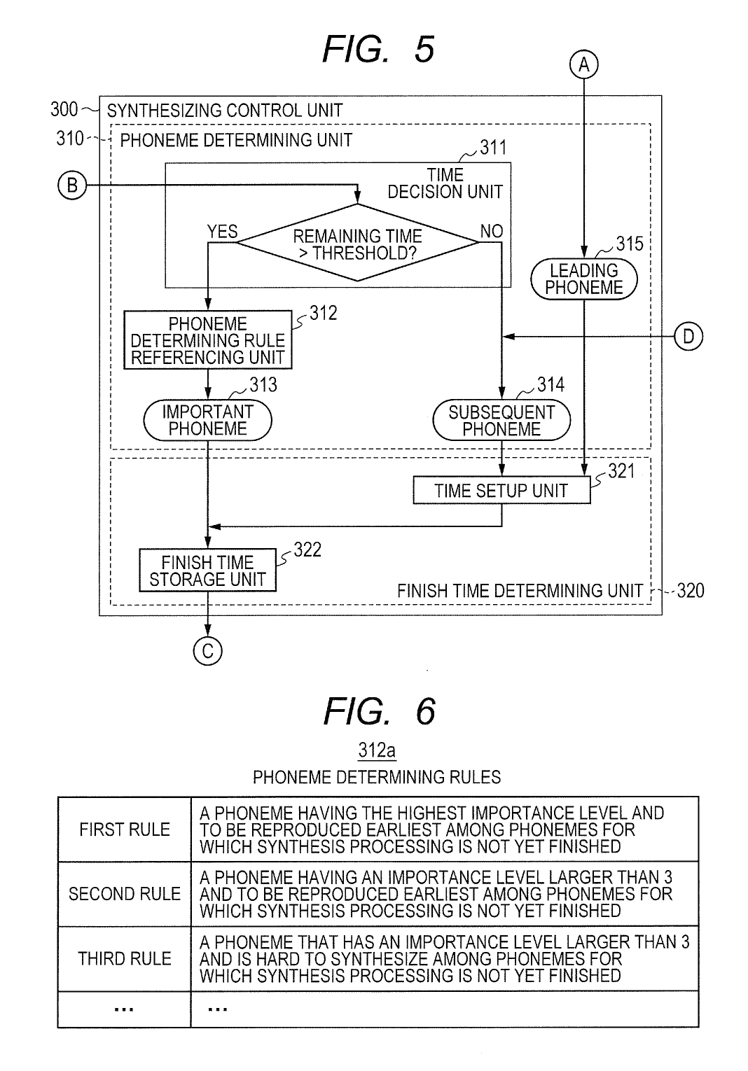

The target prediction unit 230 acquires the middle language with per-word importance levels 221 and generates targets for synthesis for each phoneme, taking account of the importance levels of the words, context information, etc., with the aid of a target provision model 232 learned beforehand. The target prediction unit 230 outputs the generated targets for synthesis 231 to the synthesizing control unit 300 (see FIG. 5) which follows A in FIG. 3. The target provision model 232 involves a spectrum model, power model, F0 (basic frequency) model, duration model, etc.

The targets for synthesis 231 herein are feature values targeted for synthesis. Generally, the targets for synthesis 231 include basic frequency (F0), power, duration, phonologic feature (spectrum), context feature, etc. However, if information for the targets for synthesis 231 is added to a part of the input middle language, the target prediction unit 230 can generate the targets for synthesis 231 using the added information for the targets for synthesis 231 as is. In other words, the targets for synthesis 231 may be set up in advance.

The target prediction unit 230 converts, for example, the above-mentioned middle language of case 1A “{2}(k % o) (r % e)/{1}(w % a) #{4}(g % o) (s % ee)/{3}(o % N)(s % ee)/{1}(d % e)(s % u)” to the targets for synthesis 231 as shown in FIG. 4.

In FIG. 4, the targets for synthesis 231 include information regarding the following: phoneme 2311, prosodic feature 2312 (F0 information 2313, duration 2314, power 2315), phonologic feature value 2316, context feature 2317, and importance 2318.

For example, to a phoneme “k” in a first row, the following information is provided: “100 Hz” at the start of output and “120 Hz” at the end of output for F0 information 2313; “20 ms” for duration 2314; “50” for power 2315; “2.5, 0.7, 1.8, . . . ” for phonologic feature value 2316; “x-k-o-2-4-6-1 . . . ” for context feature 2317; and “2” for importance 2318. In FIG. 4, information for phonologic feature value 2316 indicates a frequency spectrum and context information 2317 indicates phonemes that precedes and follows the phoneme (however, a mark x denotes that no phoneme precedes the phoneme “k”) and word class information, respectively.

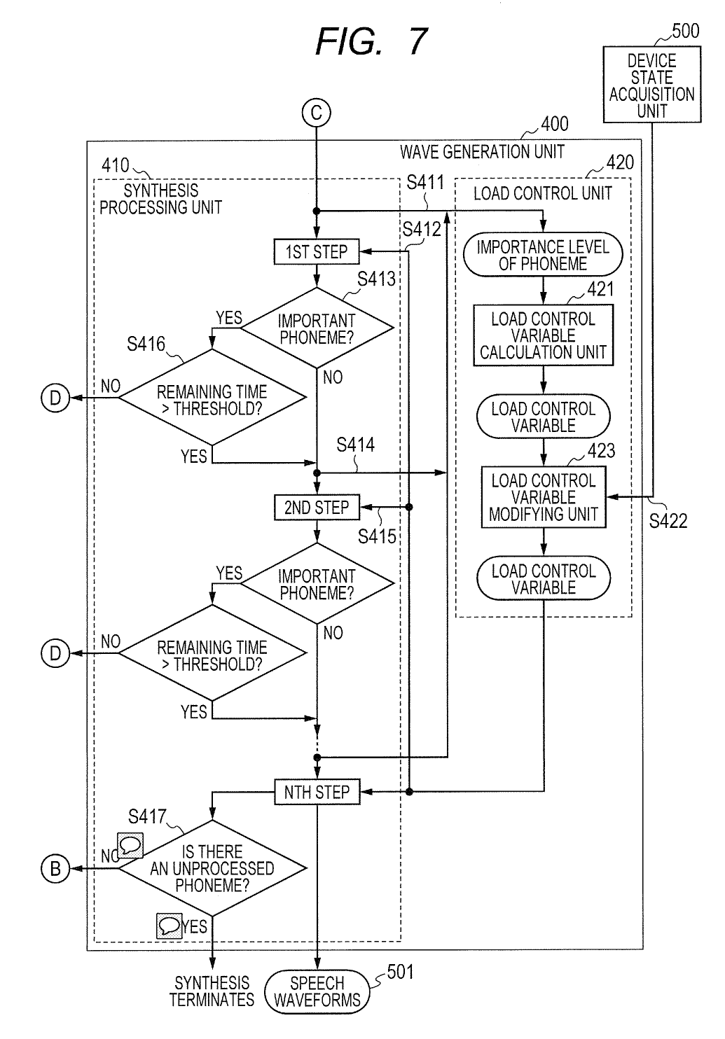

Next, the operation of the synthesizing control unit 300 is described using FIG. 5 (see FIGS. 2 and 3, as appropriate). The synthesizing control unit 300 includes the phoneme determining unit 310 and the finish time determining unit 320. In FIG. 5, the phoneme determining unit 310 acquires targets for synthesis 231 which have been output from the target prediction unit 230 (input of A in FIG. 5). Based on phoneme determining rules 312a (see FIG. 6) which will be described later, the phoneme determining unit 310 determines a phoneme that is next to be synthesized (its waveform is generated) (which is hereinafter referred to as a next synthesized phoneme) by the synthesis processing unit 410 (see FIG. 7) in the wave generation unit 400 which will be described later.

The phoneme determining unit 310 determines, as a next synthesized phoneme, any of the following: (1) a leading phoneme (heading phoneme) 315 listed in the targets for synthesis 231 acquired; (2) a subsequent phoneme 314 that is reproduced next to a phoneme(s) for which synthesis (waveform generation) has already been finished; and (3) an important phoneme 313 with a higher importance level among phonemes for which synthesis (waveform generation) is not yet finished in the text data 101. Specifically, the phoneme determining unit 310 determines a next synthesized phoneme as follows.

Case 2A (input of A in FIG. 5): when the phoneme determining unit 310 has newly acquired targets for synthesis 231 from the text processing unit 200, it determines the leading phoneme 315 in the acquired targets for synthesis 231 as the next synthesized phoneme.

Case 2B (input of D in FIG. 5): when, during processing by the synthesis processing unit 410 (see FIG. 7) which will be described later, the process has been returned because the synthesis start time for a next synthesized phoneme has come or for other reasons, the phoneme determining unit 310 determines a subsequent phoneme 314 that follows a phoneme(s) for which synthesis has already been finished (the subsequent phoneme 314 is the one that is next reproduced and may be an important phoneme 313) as the next synthesized phoneme.

Case 2C (input of B in FIG. 5): when the synthesis processing unit 410 (see FIG. 7) which will be described later has finished processing of the targets for synthesis 231 for a phoneme and the process has been returned for processing for a next phoneme (output of B in FIG. 7), a time decision unit 311 decides whether or not a remaining time corresponding to a value calculated by subtracting the current time from a target finish time is greater than a threshold that has been set beforehand. If the remaining time is equal to or less than the threshold (No decided by the decision unit 311), the phoneme determining unit 310 determines a subsequent phoneme 314 as the next synthesized phoneme. Otherwise, if the remaining time is greater than the threshold (Yes decided by the decision unit 311), the phoneme determining unit 310 determines, as the next synthesized phoneme, an important phoneme 313 determined by a phoneme determining rule referencing unit 312 based on the phoneme determining rules 312a (see FIG. 6).

Here, the important phoneme 313 is a phoneme determined according to the phoneme determining rules 312a (see FIG. 6) stored in the phoneme determining rule referencing unit 312. The phoneme determining rules 312a are given as, for example, first through third rules shown in FIG. 6. A first rule stipulates that “a phoneme having the highest importance level and to be reproduced earliest among phonemes for which synthesis processing is not yet finished” is taken as an important phoneme 313. A second rule stipulates that “a phoneme having an importance level larger than 3 and to be reproduced earliest among phonemes for which synthesis processing is not yet finished” is taken as an important phoneme 313. A third rule stipulates that “a phoneme that has an importance level larger than 3 and is hard to synthesize among phonemes for which synthesis processing is not yet finished” is taken as an important phoneme 313. The phoneme that is hard to synthesize is a phoneme for which synthesis processing different from normal processing is required; for example, a phoneme involving adjacent vowels and a phonological change, among others. The phoneme determining rule referencing unit 312, for example, applies the first through third rules in ascending order, takes a phoneme that meets any of the rules as an important phoneme 313, and determines the next synthesized phoneme.

A real-time speech synthesis system of related art performs synthesis processing of phonemes in order from the beginning of a text. By contrast, the speech synthesizer 10 according to the present embodiment may synthesize an important phoneme earlier than other phonemes not in accordance with order from the beginning of a text. This is for the purpose of making synthesis processing less affected by a fluctuation in the processing load and synthesizing important words at a high quality. As described previously, time allocated for processing an important phoneme may be set also in a case where synthesis of another phoneme has finished earlier than its target finish time. In other words, the synthesizer 10 is intrinsically arranged to curtail the processing load when synthesizing a word whose importance level is not high. Thus, synthesis of an unimportant word may finish at a time earlier than its target finish time. In such a case, synthesis processing of an important word is performed using a surplus processing time. Thereby, the speech synthesizer 10 enables making synthesis processing less affected by a fluctuation in the processing capability of resources and synthesizing important words at a high quality.

Returning to FIG. 5, depending on the type of the next synthesized phoneme determined by the phoneme determining unit 310, the finish time determining unit 320 determines a target finish time, i.e., a time instant by which synthesis processing of the phoneme should be finished.

Specifically, if the next synthesized phoneme is a leading phoneme 315, the finish time determining unit 320 sets a target finish time equal to a voice output response time (a period of time after the input of text until a first voice output occurs) which is predetermined by a time setup unit 321. The voice output response time may be specified by a user or determined depending on the importance level of text. The time setup unit 321 stores the set target finish time into a finish time storage unit 322.

If the next synthesized phoneme is a subsequent phoneme 314, the finish time determining unit 320 sets a target finish time equal to a time to start the reproduction of synthesized speech of this phoneme (a time at which a speech waveform 501 (see FIG. 7) of this phoneme is output from the voice output unit 320), which is determined by the time setup unit 321. The time setup unit 321 stores the set target finish time into the finish time storage unit 322.

If the next synthesized phoneme is an important phoneme 313 determined by the phoneme determining rule referencing unit 312, the time setup unit 321 does not set up a target finish time and the finish time determining unit 320 sets a target finish time equal to the time stored currently in the finish time storage unit 322. The reason for this is because synthesis processing of the important phoneme 313 is performed using a remaining time in a case that synthesis of another phoneme has finished earlier than its target finish time (the time stored currently in the finish time storage unit 322). Synthesis processing of the important phoneme 313 terminates upon the target finish time (the time stored currently in the finish time storage unit 322) set for another phoneme for which synthesis has finished earlier or when synthesis processing of the important phoneme 313 has been completed.

Information for the target finish time determined by the finish time determining unit 320 (target finish time information) and information for the next synthesized phoneme determined by the phoneme determining unit 310 (next synthesized phoneme information) are output together with the targets for synthesis 231 (see FIG. 3) to the wave generation unit 400 (see FIG. 7) (output of C in FIG. 5).

Next, the operation of the wave generation unit 400 is described using FIG. 7. As shown in FIG. 7, the wave generation unit 400 includes the synthesis processing unit 410 and the load control unit 420.

The synthesis processing unit 410 acquires the targets for synthesis 231, next synthesized phoneme information, and finish time information from the synthesizing control unit 300 (input of C in FIG. 7).

Then, the synthesis processing unit 410 eventually generates a speech waveform 501 of a phoneme. Specifically, the synthesis processing unit 410 generates the speech waveform 501 of the phoneme specified as the next synthesized phoneme based on the next synthesized phoneme information by executing a plurality of steps (N steps from the first step to the Nth step in FIG. 7). Here, these steps represent, for example, making a gradual selection of candidates of speech waveforms so as to narrow down the number of candidates, as the process proceeds from the first step to the N step. The synthesis processing unit 410 is arranged to be allowed to change the processing load for each step. Although details will be described later, the synthesis processing unit 410 accesses the load control unit 420 before executing each step, acquires a load control variable which is determined based on the importance level and the device load state, and executes each step based on the load control variable.

The load control unit 420 determines a load control variable for each step to be executed by the synthesis processing unit 410. When the load control unit 420 has been accessed from the synthesis processing unit 410 that requests a load control variable, a load control variable calculation unit 421 first calculates a load control variable based on the importance level of the phoneme to be synthesized. For example, the load control unit 420 sets a load control variable to ensure a high quality (allocate larger resources), if the phoneme has a higher importance level. In another case, for the phoneme having a low importance level, the load control unit 420 sets a load control variable for curtailing the processing load consumed for synthesis processing, which is given priority over sound quality.

Then, a load control variable modifying unit 423 in the load control unit 420 acquires device information at the current time from the device state acquisition unit 500 (S422) The device information is, for example, an upper limit value of resources that can be assigned to the processing. Then, the load control variable modifying unit 42 modifies the load control variable calculated by the load control variable calculation unit 421 based on the device information and outputs the final load control variable to the synthesis processing unit 410.

If the phoneme to be synthesized is a leading phoneme 315 or subsequent phoneme 314, its synthesis needs to finish within its target finish time and, thus, the load control unit 420 sets a load control variable so that the synthesis will finish within the target finish time, taking account of the device information and a remaining time (a difference between the target finish time and the current time).

In FIG. 7, the synthesis processing unit 410 executes the N steps from the first step to the Nth step in order for one phoneme and generates a speech waveform 501. In this regard, before executing the first step, the synthesis processing unit 410 accesses the load control unit 420 (S411) and acquires a load control variable for the first step (S412). The synthesis processing unit 410 executes the first step based on the load control variable and, after the first step execution, decides whether or not the processed phoneme is an important phoneme 313 (S413). If the processed phoneme is not an important phoneme 313 (No as decided at S413), that is, if the processed phoneme is a leading phoneme 315 or subsequent phoneme 314, the synthesis processing unit 410 proceeds to the second step.

Then, before starting the second step, the synthesis processing unit 410 accesses the load control unit 420 (S414), acquires a load control variable for the second step (S415) and executes the second step based on the load control variable.

If the processed phoneme is an important phoneme 313 at S413 (Yes as decided at S413), the synthesis processing unit 410 decides whether or not a remaining time is greater than the threshold (S416). If is has decided that the remaining time is greater than the threshold (Yes as decided at S416), the process goes to the second step. If having decided that the remaining time is equal to or less than the threshold (No as decided at S416), the synthesis processing unit 410 returns the process to the synthesizing control unit 300 (see FIG. 5) (output of D in FIG. 7). The reason for provision of the output of D in FIG. 7 is because it is needed to break off the process if the remaining time is almost running out (it has become equal to or less than the threshold) due to the fact that synthesis processing of an important phoneme 313 is performed during a remaining time for another phoneme for which synthesis has finished before its target finish time. At this time, the synthesis processing unit 410 stores results of execution of a step(s) already executed for the phoneme in process. When restarting the synthesis processing of the phoneme in process, the synthesis processing unit 410 begins with a step following the executed step(s).

By repeating the same process as the process from the first step to the second step as described above up to the Nth step, the synthesis processing unit 410 executes the N steps in order for one phoneme and generates a speech waveform 501 for the phoneme. Besides, the synthesis processing unit 410 decides whether or not there is an unprocessed phoneme in text data 101 (see FIG. 3) (S417). If having decided that there is an unprocessed phoneme (Yes as decided at S417), the synthesis processing unit 410 returns the process to the phoneme determining unit 310 (output of B in FIG. 7) and continues the speech waveform synthesis process. If having decided that there is not an unprocessed phoneme (No as decided at S417), the synthesis processing unit 410 terminates the synthesis process.

Speech waveforms 501 generated by the synthesis processing unit 410 are output to the voice output unit 600 (see FIG. 2), stored in an output buffer not shown, and output at predetermined timing to the speaker or the like so that real-time performance is maintained.

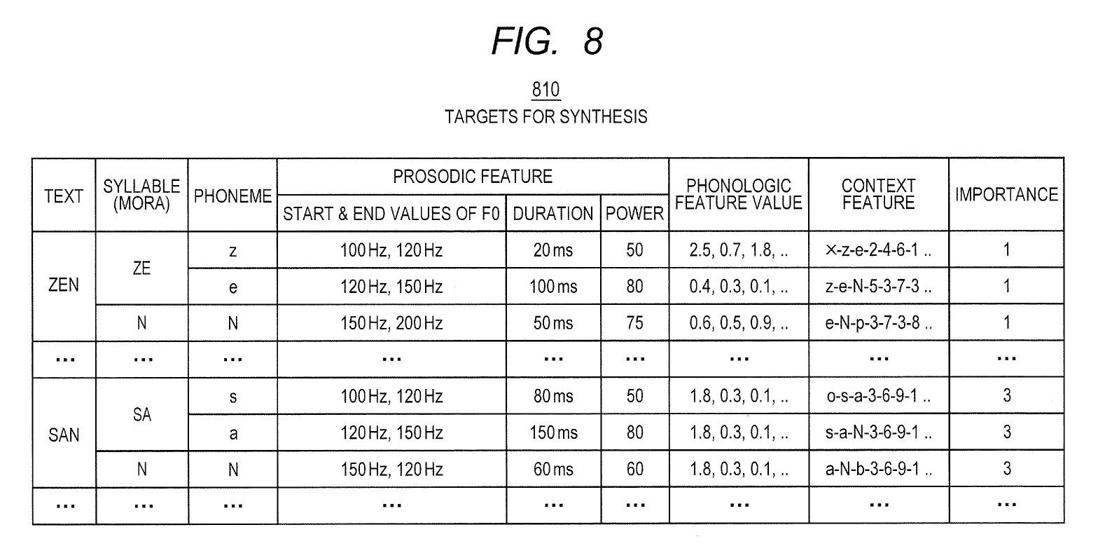

Now, descriptions are provided for concrete examples of processing that is performed by the synthesizing control unit 300 shown in FIG. 5 and the wave generation unit 400 shown in FIG. 7 by way of FIGS. 8 through 14 (see FIGS. 5 and 7 as appropriate).

Targets for synthesis 810 shown in FIG. 8 are an example of the targets for synthesis 231 (see FIG. 3) which are input to the phoneme determining unit 310. The targets for synthesis 810 list target values for “zen” and “san” in the text “zenpou sanbayku meitoru saki, migi ni magarimasu” in Japanese language, which means “turn to the right 300 meters ahead forward”, and omit those for other words. In the following description, it is assumed that the threshold that is used by the time decision unit 311 in the phoneme determining unit 310 is 20 ms and the voice output response time (a period of time after the input of text until a first voice output occurs) is 200 ms.

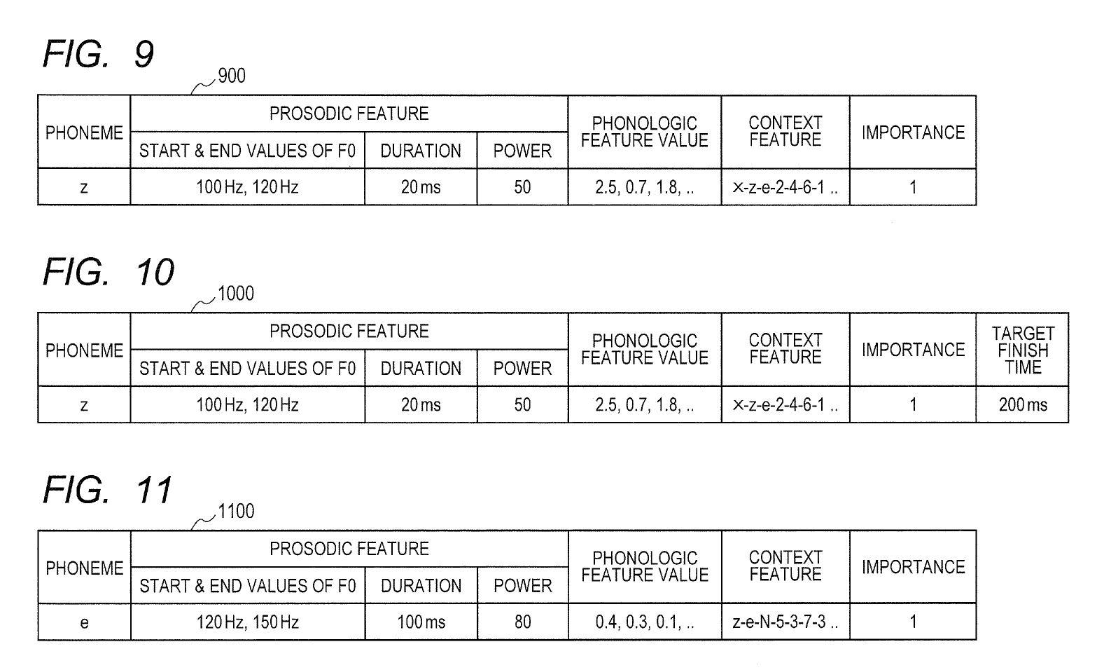

When the targets for synthesis 810 have newly been input as the input of A in FIG. 5, the phoneme determining unit 310 first determines “z” that is the leading phoneme 315 as the next synthesized phoneme. FIG. 9 shows the targets for synthesis 900 for “z” determined as the next synthesized phoneme. Then, the finish time determining unit 320 sets 200 ms, which is the voice output response time, as the target finish time. FIG. 10 shows the targets for synthesis 1000 for “z” to which target finish time information was added. The synthesis processing unit 410 performs synthesis processing of “z”, using the targets for synthesis 1000 as the input of C in FIG. 7.

Then, when the synthesis processing unit 410 has finished the synthesis processing of the leading phoneme “z”, the process is returned to the phoneme determining unit 310a through B in FIG. 7 (input of B in FIG. 5), because unprocessed phonemes still remain. The time decision unit 311 in the phoneme determining unit 310 compares a remaining time at this point of time with the threshold and determines a next synthesized phoneme.

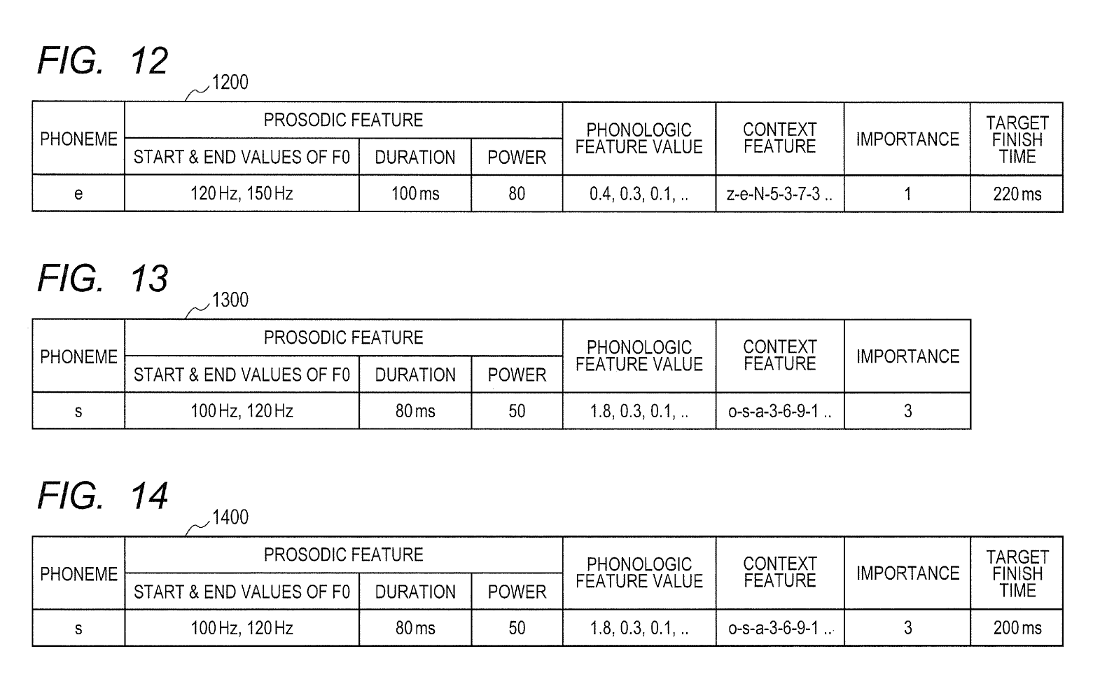

If the remaining time is, for example, 5 ms, it is less than the threshold of 20 ms and, thus, the phoneme determining unit 310 determines “e” that is a subsequent phoneme 314 following “z” as the next synthesized phoneme. FIG. 11 shows the targets for synthesis for “e” extracted as the next synthesized phoneme. The finish time determining unit 320 adds the speech duration of 20 ms for “z” to the above-mentioned target finish time (=200 ms) and sets the target finish time to 220 ms. FIG. 12 shows the targets for synthesis 1200 for “e” to which target finish time information was added.

In another case, if the remaining time is, for example, 50 ms, it is greater than the threshold of 20 ms and, thus, the phoneme determining rule referencing unit 312 in the phoneme determining unit 310 refers to the phoneme determining rules 312a (see FIG. 6) and determines a next synthesized phoneme Specifically, the phoneme determining unit 310 determines “s” as the next synthesized phoneme, taking “s” that is a phoneme having the highest importance level (a phoneme with importance level 3 in FIG. 8) and to be reproduced earliest among phonemes for which synthesis is not yet finished (phonemes subsequent to “z” in FIG. 8) as an important phoneme 313. FIG. 13 shows the targets for synthesis 1300 for “s” extracted as the next synthesized phoneme. Since the finish time determining unit 320 does not set a target finish time newly for an important phoneme 313 determined by the phoneme determining rule referencing unit 312, it sets the target finish time of 200 ms for “z”, as is, as the target finish time for “s”. FIG. 14 shows the targets for synthesis 1400 for “s” to which target finish time information was added.

However, in the synthesis processing unit 410, if it is decided at a decision step such as S416 that a remaining time is equal to or less than the threshold and, during synthesis processing of “s” that is an important phoneme 313, the process is returned from the synthesis processing unit 410 to the phoneme determining unit 310 through D in FIG. 7 (input of D in FIG. 5), then the phoneme determining unit 310 determines “e” that is a subsequent phoneme 314 following “z”, synthesized already, as the next synthesized phoneme.

As described previously, in a case where synthesis processing of a phoneme has finished at a time earlier than its target finish time, the speech synthesizer 10 performs synthesis processing of an important phoneme 313 using a surplus processing time. Thereby, the speech synthesizer 10 can make synthesis processing less affected by a fluctuation in the processing load and can synthesize important words at a high quality.

Then, descriptions are provided for time sequence of speech synthesis processing by the speech synthesizer 10, using FIGS. 15A and 15E. In FIGS. 15A and 15B, the abscissa indicates time (t) and the ordinate indicates CPU occupancy as an example of resources for speech synthesis processing. CPU occupancy represents an upper limit of resources that the CPU can assign to speech synthesis processing and is to be determined based on a relation between the synthesis processing and other processes that the CPU runs. Hatched and dotted patterns plotted in the fields of CPU occupancy denote that synthesis processing for a word corresponding to a pattern shown in the legend field has been executed. Each of vertical lines that separate words indicates a target finish time of synthesis processing of each word. FIG. 15A shows a graphical representation of speech synthesis processing according to related art and FIG. 15B shows a graphical representation of speech synthesis processing by the speech synthesizer 10 pertaining to the present embodiment. Each of hatched and other pattern regions in FIGS. 15A and 15B represents an amount of load consumed for synthesis processing of each word.

FIGS. 15A and 15B show examples where speech synthesis is performed for a text “zenpou sanbayku meitoru saki, migi ni magarimasu” in Japanese language, which means “turn to the right 300 meters ahead forward”. Importance levels are given to the words of the text as follows: 2, 3, 2, 1, 4, 1, and 1 to “zenpou (forward)”, “sanbayku (300)”, “meitoru (meters)”, “saki (ahead)”, “migi (the right)”, “ni (to)”, and “magarimasu (turn)”, respectively.

In the case of speech synthesis processing according to related art shown in FIG. 15A, the words contained in the text are speech synthesized from the beginning independently of the importance levels. Therefore, in speech synthesis processing according to related art, the quality of synthesized speech is adjusted depending on the CPU occupancy in order to maintain real-time performance. That is, in speech synthesis processing according to related art, the quality of synthesized speech is degraded, when the CPU occupancy is low and there is a smaller amount of resources assigned to speech synthesis processing. In FIG. 15A, the CPU occupancy becomes relatively low at timing to synthesize “migi (right)” with the highest importance level. Consequently, the sound quality of an important word “migi” becomes relatively poor, which might make the important word hard to hear.

In contrast, in the case of speech synthesis processing according to the present embodiment shown in FIG. 15B, resources for synthesis processing are set depending on the importance level of a word and a word with a low importance level is speech synthesized in a short time. In the speech synthesis processing according to the present embodiment, an important word is preferentially speech synthesized during a surplus processing time. Thereby, the speech synthesis processing pertaining to the present invention enables making synthesis processing less affected by a fluctuation in the CPU occupancy, keeping the quality of important words high, and making important words easily audible.

Specifically, in FIG. 15B, the synthesis processing of a leading word “zenpou (forward)” finishes in a short time, because its importance level is rather low (importance level 2) and the synthesis processing of a word “sanbyaku (300)” whose importance level is rather high (importance level 3) starts in a surplus time (a period until the target finish time for “zenpou”), i.e., the remaining time. When the synthesis processing of the word “sanbyaku” has finished, a time remains until its target finish time and, thus, the synthesis processing of a word “migi (right)” with a high importance level (importance level 4) starts. In this way, the speech synthesizer 10 pertaining to the present embodiment performs the synthesis processing of an important word earlier than other words, using a surplus processing time. Thereby, the speech synthesizer 10 enables making synthesis processing less affected by a fluctuation in the processing load, speech synthesizing of important words at a high quality, and making important words easily audible, while ensuring real-time performance.

As described in the foregoing paragraphs, the speech synthesizer 10 pertaining to the first embodiment divides input text data 101 into a plurality of components (words in concrete terms) and estimates an importance level of each of the components according to the degree of how much each component contributes to understanding when a listener hears synthesized speech. Then, the speech synthesizer 10 determines a processing load based on the device state when executing synthesis processing and the importance level. The speech synthesizer 10 reduces the processing time for a phoneme with a low importance level by curtailing its processing load (relatively degrading its sound quality), allocates a part of the processing time, made available by this reduction, to the processing time of a phoneme whose importance level is high, and generates synthesized speech in which important words are easily audible. Thus, the speech synthesizer 10 enables making synthesis processing less affected by a fluctuation in the resources, speech synthesizing of important words at a high quality, and making important words easily audible, while ensuring real-time performance.

### Second Embodiment

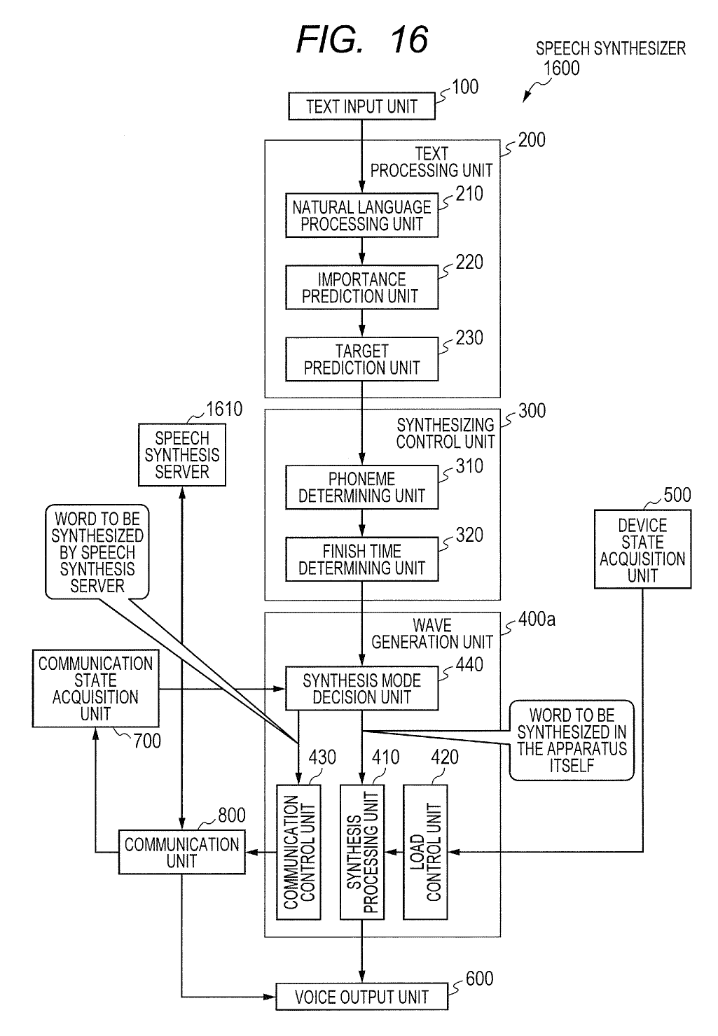

Functional configuration of a speech synthesizer 160 pertaining to a second embodiment is described using FIG. 16. In FIG. 16, components corresponding to those in FIG. 2 are assigned the same reference numerals and their description is not repeated.

The speech synthesizer 1600 includes a communication unit 800 and is configured to transmit an important component of a text for speech synthesis to a speech synthesis server 1610 and causes the speech synthesis server 1610 to perform speech synthesis processing of the important component. The speech synthesis server 1610 is assumed to have ample resources for synthesis processing. Then, the speech synthesizer 1600 receives synthesized speech of the important component synthesized at a high quality by the speech synthesis server 1610 via the communication unit 800. On the other hand, the speech synthesizer 1600 performs speech synthesis processing of an unimportant component of a text for speech synthesis in the apparatus itself. Thereby, the speech synthesizer 1600 can generate synthesized speech in which important words are easily audible, while ensuring real-time performance.

The speech synthesizer 1600 further includes an input unit 100, text processing unit 200, synthesizing control unit 300, wave generation unit 400a, device state acquisition unit 500, and voice output unit 600, as is the case for the speech synthesizer 10 pertaining to the first embodiment. The speech synthesizer 1600 further includes a communication state acquisition unit 700 and the communication unit 800.

The communication state acquisition unit 700 acquires information about a communication state in which the communication unit 800 is placed. The communication unit 800 communicates with the speech synthesis server 1610, regardless of wired or wireless communication. The speech synthesis server 1610 generates a speech waveform for an important component of a text received and transmits the generated speech waveform to the speech synthesizer 1600. Speech waveforms generated by the speech synthesis server 1610 can be expected to have a higher quality than speech synthesized by the speech synthesizer 1600. The voice output unit 600 buffers speech waveforms of important components received via the communication unit 800 and speech waveforms generated in the apparatus itself into an output buffer (not shown) and outputs these waveforms in proper order.

The wave generation unit 400a of the speech synthesizer 1600 includes a synthesis processing unit 410 and a load control unit 420 just like the wave generation unit 400 (see FIG. 2) of the speech synthesizer 10 pertaining to the first embodiment and, besides, includes a communication control unit 430 and a synthesis mode decision unit 440. The communication control unit 430 controls the operation of the communication unit 800.

The synthesis mode decision unit 440 decides a mode of speech synthesis based on information about a communication state acquired by the communication state acquisition unit 700. Specifically, the synthesis mode decision unit 440 decides, e.g., for each word included in a text, whether its speech waveform should be generated in the apparatus itself or by the speech synthesis server 1610.

For example, when the communication state is good, the synthesis mode decision unit 440 decides that even a phoneme with a low importance level should be synthesized by the speech synthesis server 1610. On the other hand, when the communication state is bad, the synthesis mode decision unit 440 decides that only a phoneme with a high importance level (a phoneme whose importance level is equal to or higher than a predetermined importance level) should be processed by the speech synthesis server 1610. In an extreme case where the communication unit 800 cannot perform communication at all, the synthesis mode decision unit 440 decides that all phonemes should be synthesized in the speech synthesizer 1600.

Furthermore, the synthesis mode decision unit 440 may decide a timing to transmit/receive data to/from the speech synthesis server 1610 and order in which data should be transmitted/received based on the communication state of the communication unit 800. For example, the synthesis mode decision unit 440 makes transmissions of important phonemes less affected by a change in the communication environment transmissions by distributing the timings to transmit important phonemes on the time axis. Such handling is effective for devices (e.g., car navigation equipment and the like) operating in an unstable communication environment whose fluctuation is unpredictable.

Now, the operation of the wave generation unit 400a is described using FIG. 16.

In FIG. 16, the synthesis mode decision unit 440 in the wave generation unit 400a acquires an output of the synthesizing control unit 300 and sorts words included within the targets for synthesis 810 (see FIG. 8) into a word to be speech synthesized by the speech synthesis server 1610 and a word to be speech synthesized in the apparatus itself, based on information about a communication state acquired by the communication state acquisition unit 700.

A word judged to be speech synthesized in the apparatus itself is processed by the synthesis processing unit 410 in the same way as for the first embodiment and output as a speech waveform 501 (see FIG. 7) to the voice output unit 600. On the other hand, a word judged to be speech synthesized by the speech synthesis server 1610 is transmitted by the communication control unit 430 through the communication unit 800 to the speech synthesis server 1610. At this time, the communication control unit 430 controls a timing to transmit a word and a timing to receive a speech waveform generated by the speech synthesis server 1610. A word speech synthesized by the speech synthesis server 1610 received through the communication unit 800 is output as a speech waveform 501 to the voice output unit 600.

As above, the speech synthesizer 1600 (see FIG. 16) pertaining to the second embodiment sorts words in input text data 101 into a word to be speech synthesized by the speech synthesis server 1610 and a word to be speech synthesized in the apparatus itself, based on the communication state acquired by the communication state acquisition unit 700. For example, an important component (word) of text data 101 is transmitted to the speech synthesis server 1610 and processed at a high quality and the apparatus acquires its processed speech waveform 501 from the speech synthesis server 1610. On the other hand, for an unimportant component, its speech waveform 501 is generated in the apparatus itself. Thereby, the speech synthesizer 1600 can generate synthesized speech in which important words are easily audible, while ensuring real-time performance.

### Third Embodiment

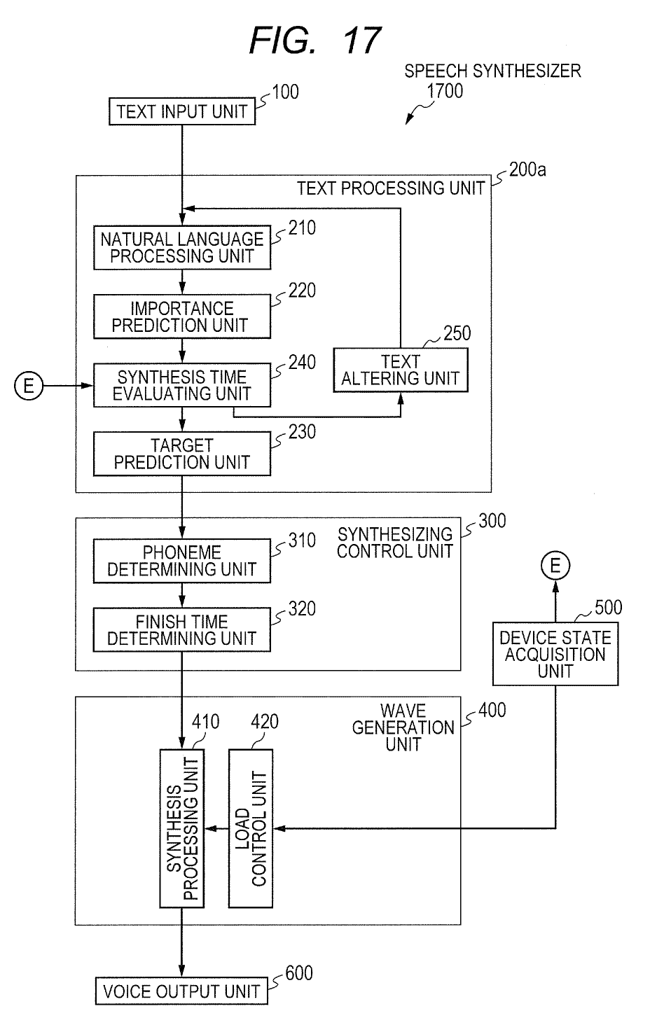

Functional configuration of a speech synthesizer 1700 pertaining to a third embodiment is described using FIG. 17. The speech synthesizer 1700 pertaining to the third embodiment estimates an importance level of each word in an input text based on the degree of how much the word contributes to understanding the meaning of the input text, as is the case for the speech synthesizer 10 of the first embodiment. Then, the speech synthesizer 1700 processes an important word, as is, into synthesized speech. But, as for an unimportant component, the apparatus alters its text wording so that the component can be processed in a shorter time before its synthesis processing. The reason for this is to ensure resources that are assigned to synthesis processing of an important word, even if resources available for assignment to synthesis processing are limited. By this manner of processing, the speech synthesizer 1700 enables speech synthesizing of important words at a high quality, while ensuring real-time performance, and, therefore, can generate synthesized speech in which important words are easily audible. In FIG. 17, components corresponding to those of the speech synthesizer 10 pertaining to the first embodiment, shown in FIG. 2, are assigned the same reference numerals and their detailed description is not repeated.

As shown in FIG. 17, the speech synthesizer 1700 includes an input unit 100, text processing unit 200a, synthesizing control unit 300, wave generation unit 400, device state acquisition unit 500, and voice output unit 600, as is the case for the speech synthesizer 10 (see FIG. 2).

Here, the text processing unit 200a of the speech synthesizer 1700 includes a natural language processing unit 210, importance prediction unit 220, and target prediction unit 230, which are the same components as those provided in the text processing unit 200 of the first embodiment, and, besides, further includes a synthesis time evaluating unit 240 and a text altering unit 250.

The synthesis time evaluating unit 240 is connected to the device state acquisition unit 500 and, based on device state information acquired from the device state acquisition unit 500, predicts a time taken for synthesis processing of a word and calculates a predicted time, i.e., a time instant at which synthesis processing of the word is predicted to finish. Then, the synthesis time evaluating unit 240 compares the predicted and the target finish time for the word and decides whether or not the predicted time exceeds the target finish time. If the synthesis time evaluating unit 240 has decided that the predicted time exceeds the target finish time, it outputs text data to the text altering unit 250.

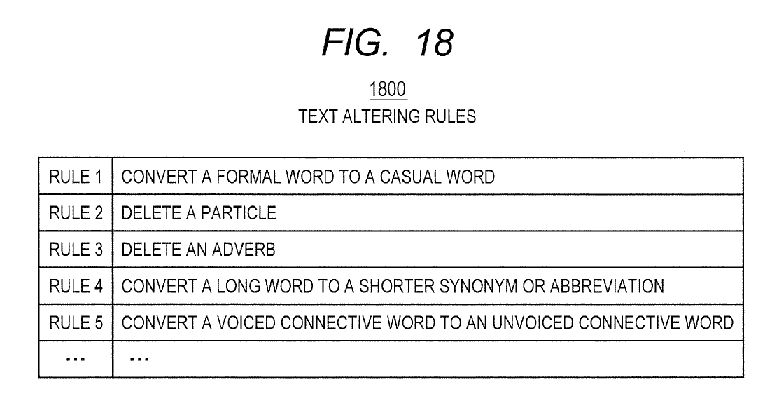

Based on text altering rules 1800 (see FIG. 18) which will be described later, the text altering unit 250 alters a word corresponding to a component having a small effect on understanding the meaning of the text (that is, a component whose importance level is relatively low), so that synthesis of the word can finish in a shorter time.

Now, an example of text altering rules 1800 is described using FIG. 18. As shown in FIG. 18, the text altering rules 1800 may be defined as follows: “convert a formal word to a casual word” as rule 1; “delete a particle” as rule 2; “delete an adverb” as rule 3; “convert a long word to a shorter synonym or abbreviation” as rule 4; “convert a voiced connective word to an unvoiced connective word” as rule 5; and so on. These rules can help to make a relative reduction in the processing load for speech synthesis processing and, for example, those learned by a statistical method can be used. The speech synthesizer 1700 alters text wording by applying the text altering rules 1800 in order from rule 1 until the predicted time falls within the target finish time.

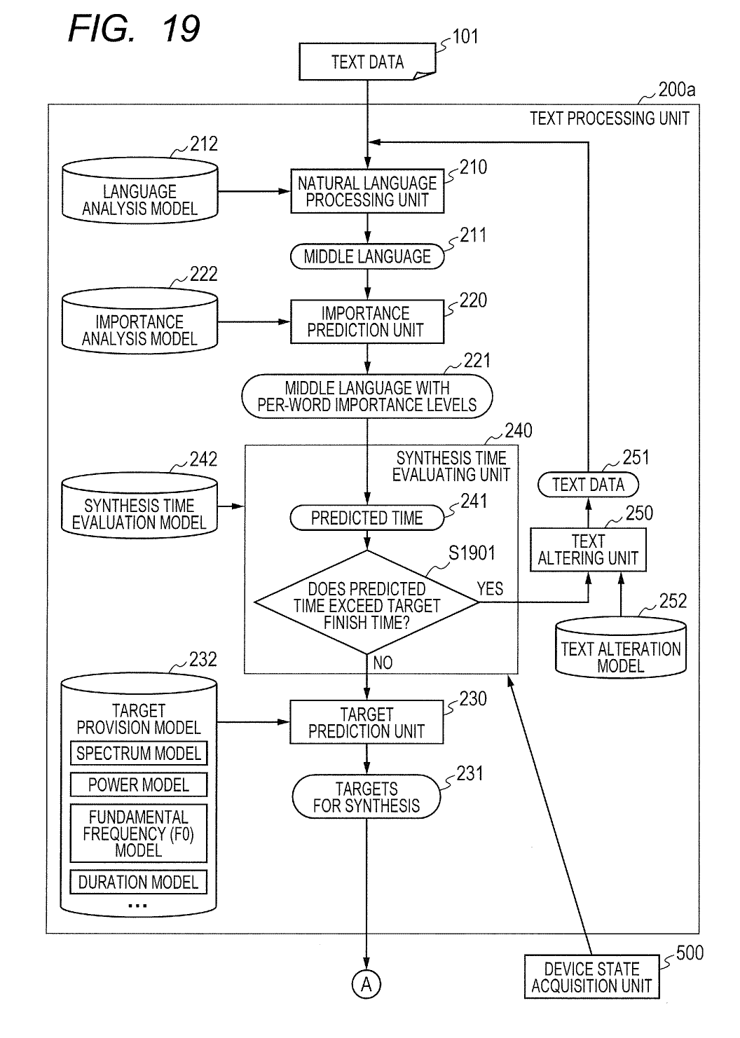

The operation of the text processing unit 200a is described using FIG. 19. In the third embodiment, the components other than the text processing unit 200a operate in the same way as in the first embodiment and, hence, their detailed description is not repeated. In FIG. 19, first, the natural language processing unit 210 in the text processing unit 200a acquires text data 101 from the input unit 100 (see FIG. 2). The natural language processing unit 210 converts the text data 101 to a middle language 211 with the aid of a language analysis model 212 created beforehand.

The importance prediction unit 220 estimates the importance levels of all words included in the middle language 211 with the aid of an importance analysis model 222. Then, the importance prediction unit 220 adds estimated importance information to the middle language 211 and outputs it as a middle language with per-word importance levels 221 to the synthesis time evaluating unit 240.

The synthesis time evaluating unit 240 predicts a time taken for synthesis processing of a word and calculates a predicted time for the word, based on device state information acquired by the device state acquisition unit 500 and a synthesis time evaluation model 242. Then, the synthesis time evaluating unit 240 compares the predicted time and the target finish time for the word and decides whether the predicted time exceeds the target finish time (S1901). If the synthesis time evaluating unit 240 has decided that the predicted time exceeds the target finish time (Yes as decided by the synthesis time evaluating unit 240), it outputs the text data 101 to the text altering unit 250. Otherwise, if the synthesis time evaluating unit 240 has decided that the predicted time does not exceed the target finish time (No as decided by the synthesis time evaluating unit 240); it outputs the middle language with per-word importance levels 221 to the target prediction unit 230, as is the case for the first embodiment.

The text altering unit 250 alters the text data 101 based on the text altering rules 1800 (see FIG. 18) stored in a text alteration model 252 and generates text data 251. At this time, the text altering unit 250 determines a component (word) to be altered, based on the importance levels of the words contained in the text. That is, the text altering unit 250 does not alter a word that contributes to understanding the meaning of the text to a large degree and preferentially alters a word whose importance level is relatively low, so that the understanding of the text meaning is not affected. The text data 251 after the alteration is input again to the natural language processing unit 210 and text alteration processing is repeated until the predicted time 241 for the word falls within the target finish time.

As above, the speech synthesizer 1700 (see FIG. 17) pertaining to the third embodiment, if having decided that the predicted time at which speech synthesis processing will finish exceeds the target finish time, alters text data 101 (FIG. 19) so that the synthesis processing will finish within the target finish time. Thereby, the speech synthesizer 1700 ensures resources for assignment to synthesis processing of important words and enables speech synthesizing of important words at a high quality, eve if resources available for assignment to synthesis processing are limited, and can generate synthesized speech in which important words are easily audible, while ensuring real-time performance.

As described hereinbefore, the speech synthesizer and speech synthesizing method pertaining to the present invention are effectual for an information processing terminal that executes speech synthesis processing for which real-time performance is required and, particularly, effectual for a device in which a plurality of processes are run concurrently and a fluctuation in the processing capability of resources is unpredictable (for example, car navigation equipment, navigation equipment, and the like that use the speech synthesizer for the purpose of speech guidance).

What is claimed is:

1. A speech synthesizer that executes speech synthesis processing for converting an input text to synthesized speech signals, comprising:
an importance prediction unit that divides the input text into a plurality of components and estimates an importance level of each the component depending on the degree of how much each the component contributes to understanding the meaning of the text;
a load state acquisition unit that acquires a processing load state of the speech synthesizer;
a load control unit that, when executing a process of generating a synthesized speech signal of each the component, determines a processing load that is assigned to processing of each the component, based on the current processing load state of the speech synthesizer and the importance level; and
a synthesis processing unit that executes the process of generating a synthesized speech signal of each the component, based on the processing load determined by the load control unit.

2. The speech synthesizer according to claim 1, wherein the importance prediction unit estimates the importance level of each the component to be higher, the larger the degree of contribution of each the component to understanding the meaning of the text.

3. The speech synthesizer according to claim 2, further comprising:
a finish time determining unit that determines a target finish time representing a time instant by which the process of generating a synthesized speech signal of each the component should be finished from prosodic features of each the component;
a time decision unit that compares a remaining time, which represents a difference calculated by subtracting a time instant at which the process of generating a synthesized speech signal of each the component has finished from the target finish time, with a predetermined threshold; and
a phoneme determining unit that selects one of the components with a higher importance level among unprocessed ones of the components, if the remaining time is greater than the threshold, and selects one of the components subsequent to the component(s) for which the process of generating the synthesized speech signal has finished, if the remaining time is equal to or less than the threshold,
wherein the synthesis processing unit executes the process of generating a synthesized speech signal of one of the components selected by the phoneme determining unit.

4. The speech synthesizer according to claim 3, further comprising:
a synthesis time evaluating unit that calculates a predicted time representing a time instant at which processing of each the component is predicted to finish, based on the processing load state of the speech synthesizer, and decides whether the predicted time exceeds the target finish time; and
a text altering unit that, if it has been decided that the predicted time for a component exceeds its target finish time, alters the text to reduce the processing load that is assigned to processing of the component.

5. The speech synthesizer according to claim 2, wherein the load control unit sets a larger processing load to be assigned to processing of one of the components with a higher importance level.

6. The speech synthesizer according to claim 1, further comprising:
a communication unit for communication with another speech synthesizer that executes speech synthesis processing for converting an input text to synthesized speech signals;
a communication state acquisition unit that acquires a communication state of the communication unit; and
a synthesis mode decision unit that decides which of the synthesis processing unit and the another speech synthesizer should execute the process of generating a synthesized speech signal of each the component, based on the communication state and the importance level.

7. A navigation apparatus comprising the speech synthesizer according to claim 1 for the purpose of speech guidance.

8. A speech synthesizing method for a speech synthesizer that executes speech synthesis processing for converting an input text to synthesized speech signals, the speech synthesizing method comprising:
an importance estimation step dividing the input text into a plurality of components and estimating an importance level of each the component depending on the degree of how much each the component contributes to understanding the meaning of the text;
a load state acquisition step acquiring a processing load state of the speech synthesizer;
a load control step, when executing a process of generating a synthesized speech signal of each the component, determining a processing load that is assigned to processing of each the component, based on the current processing load state of the speech synthesizer and the importance level; and
a synthesis processing step executing the process of generating a synthesized speech signal of each the component, based on the processing load determined by the load control step.
